(19) United States
(12) Patent Application Publication
(10) Pub. No.: US 2025/0103794 A1
(43) Pub. Date: Mar. 27, 2025

(54) Synthetic Data Generation for a Document Parsing AI

(71) Applicant: The Government of the United States of America, as represented by the Secretary of the Navy, Arlington, VA (US)

(72) Inventors: Charles A. Norsworthy, Baton Rouge, LA (US); Brent A. Barré, Covington, LA (US)

(73) Assignee: The Government of the United States of America, as represented by the Secretary of the Navy, Arlington, VA (US)

(21) Appl. No.: 18/424,567

(22) Filed: Dec. 17, 2024

Related U.S. Application Data
(60) Provisional application No. 63/441,199, filed on Jan. 26, 2023.

(51) Int. Cl. G06F 40/16; G06F 40/205

(52) U.S. Cl. CPC G06F 40/16; G06F 40/205

(57) ABSTRACT

A method of training a document parsing artificial intelligence (AI) system, the method includes configuring a PYTHON data structure for generating a simulated document for training the document parsing AI system and a JAVA data structure for generating a non-simulated document for training the document parsing AI system. The method includes training the document parsing AI system based on a generated word-processing format file and on a parsed JSON file for the simulated document made via the PYTHON and JAVA data structures. The method includes parsing, a received document, with the trained document parsing AI system to determine one or more characteristics associated with textual data written to the received document, and generating an output of the parsed received document.

### CROSS-REFERENCE

This application is a nonprovisional application of and claims the benefit of priority under 35 U.S.C. § 119 based on U.S. Provisional Patent Application No. 63/441,199 filed on Jan. 26, 2023. The Provisional application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case #211377.

### TECHNICAL FIELD

The present disclosure is related to parsing a document that is formatted in a first format and generating another file format based on the parsing, and more specifically to, but not limited to, creating training, testing, and validation data for an artificial intelligence (AI) system to use for training and evaluation purposes in order to parse a document.

### BACKGROUND

Currently, in order to get training data for a document-parsing AI, one may either manually parse a document into JSON (JSON, n.d.), use pre-made configuration files to parse a document into JSON, or use an external dataset. Manually parsing a document into JSON is time consuming. Relying on pre-made configuration files is better, but sometimes text cannot be extracted from a PDF (Adobe, 2024), meaning some documents cannot be parsed into JSON correctly. Also, after a document is parsed using a configuration file, it should be manually checked, which is also time consuming. Furthermore, in order to get a specific data variation, such as a unique way of writing a table, one will have to find a pre-existing document with that variation, and then update the configuration file(s) and possibly the parsing code in order to have data that captures that variation. A pre-existing database may parse certain objects into JSON using an undesirable format.

Existing methods may include manually parsing documents into JSON, using pre-made configuration files to parse a document into JSON, and relying on pre-existing databases. There are disadvantages to these existing methods. For example, there are many, many different forms for which to manually parse. For example, on an FAA (Federal Aviation Administration) webpage entitled “Forms” (U.S. Department of Transportation, 2024) under “Export All,” there is a download link which downloads an Excel file that lists 1,221 forms as of Jan. 26, 2024.” Therefore, it takes a lot of time and effort to manually parse each one of these forms. For example, even if one were to write a configuration file for all these forms, if a new form is added, one would have to add new configuration file(s), and if an existing form is significantly changed, one would have to edit existing configuration file(s). This can be cumbersome, time-consuming, and expensive.

In a paper published in 2021 entitled “DocParser: Hierarchical Document Structure Parsing from Renderings,” when discussing “the effectiveness of DocParser for parsing the complete document structures, the authors state “that both suitable baselines and datasets for this task are hitherto lacking.” (Rausch et al., 2021)

Because of these problems, there exists a need for a solution for efficiently parsing a wide-variety of forms and/or documents, which is provided by disclosed embodiments and/or aspects described herein.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

Disclosed aspects provide for creating objects by a synthetic data generation software. The data created by this software will be the training, validation, and testing data for an Artificial Intelligence (AI) system that can, for example, convert a document (e.g., an image of a document) into a JSON representation of that document.

Disclosed aspects provide for a system incorporating AI that can parse a wide variety of forms. By generating robust synthetic data, aspects described herein can increase the total amount of data that exists for training and evaluating document-parsing AI systems.

Aspects described herein provide for a synthetic data generation system that can increase the amount of data in the world that can be used to parse a document. A pre-existing database, as used in existing systems, may parse certain objects into JSON using an undesirable JSON format. In contrasts, aspects described herein provide for creating the documents and JSON parsing. Aspects described herein also reduce the need to consider noise in the data, because creating the document provides for knowing exactly how it should be parsed. Furthermore, data variation should be relatively easy to introduce into the dataset since the created document has that variation built in.

The present disclosure provides for a method of training a document parsing artificial intelligence (AI) system. The method may include configuring, by a processing device, a PYTHON data structure for generating a simulated document for training the document parsing AI system, wherein the simulated document comprises a list of characters and associated characteristics, and configuring, by the processing device, a JAVA data structure for generating a non-simulated document for training the document parsing AI system. The method may include receiving, by the processing device, a set of one or more parameters for training the document parsing AI system, generating, by the processing device, via the JAVA data structure, a non-parsed JSON file comprising a description for a non-simulated document based on the set of one or more parameters, and reading, by the processing device, the non-parsed JSON file. The method may include generating, by the processing device, based on the reading of the non-parsed JSON file, a word-processing format file comprising a first set of one or more objects, each object of the first set being associated with a respective object type, wherein each object type in the first set corresponds to a specific and repeatable manner in which associated text of that object is placed in the non-simulated document, and generating, by the processing device, via the PYTHON data structure and based on the set of one or more parameters, a simulated document comprising a list of one or more characters associated with one or more respective characteristics. The method may include generating, by the processing device, a parsed JSON file for the simulated document comprising a second set of one or more objects, each object in the second set being associated with a respective object type, wherein each object type corresponds to a specific and repeatable manner in which associated text of that object is placed in the simulated document, and training, by the processing device, the document parsing AI system based on the generated word-processing format file and on the parsed JSON file for the simulated document. The method may include parsing, by the processing device, a received document, with the trained document parsing AI system to determine one or more characteristics associated with textual data written to the received document, and generating, by the processing device, an output of the parsed received document.

### BRIEF DESCRIPTION OF THE DRAWINGS

FIG. 1 illustrates a schematic block diagram of an exemplary system for creating training, testing, and validation data for an artificial intelligence system to use for training and evaluation purposes in order to parse a document, in accordance with one or more disclosed aspects.

FIG. 2 illustrates a block diagram of an exemplary JAVA data structure for creating training, testing, and validation data for an artificial intelligence system to use for training and evaluation purposes in order to parse a document, in accordance with one or more disclosed aspects.

FIG. 3 illustrates a block diagram of an exemplary PYTHON data structure for creating training, testing, and validation data for an artificial intelligence system to use for training and evaluation purposes in order to parse a document, in accordance with one or more disclosed aspects.

FIG. 4 illustrates an exemplary output derived from a JAVA data structure, in accordance with one or more disclosed aspects.

FIG. 5 illustrates an exemplary method, in accordance with one or more disclosed aspects.

FIG. 6 illustrates an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

Disclosed embodiments provide for creating synthetic training, testing, and validation data for an artificial intelligence system to use for training and evaluation purposes in order to parse a document into a JSON file, where evaluation may include validation and testing.

Disclosed embodiments provide for generating synthetic training, testing, and validation data for an AI that will parse a document into JSON. Current methods may parse FAA forms by using pre-defined configuration files for each different type of form that it encounters. It breaks the document down into a list of objects. However, one will have to create a new configuration file for each different form that exists. For example, on an FAA (Federal Aviation Administration) webpage entitled “Forms”, (U.S. Department of Transportation, 2024) under “Export All”, there is a download link which downloads an Excel file, and this file lists 1,221 forms as of Jan. 26, 2024. Even if one were to write a configuration file for all these forms, if a new form is added, one will have to add new configuration file(s), and if an existing form is significantly changed one will have to edit existing configuration file(s). Disclosed embodiments address these drawbacks.

One or more aspects may include an encoder-decoder network system, such as an AI system, that can be trained to convert a document into a JSON string. According to some aspects, in a documented experiment with this system, the system achieved an accuracy of 99.99% on its simulated testing documents.

Disclosed embodiments provide for randomly creating word-processing documents that comprise or consist of a random selection of pre-defined objects, each with random characteristics (such as the number of rows a table has) and random strings. This will create a document that will function like a password, meaning that if an AI correctly parses this document, it probably did not randomly guess what its structure is. And since the software is creating the document from scratch, it knows what the correct JSON parsing is and can record this in a JSON file.

In one example, disclosed embodiments provide for creating synthetic training, validation, and testing data for a document parsing AI will use JAVA and PYTHON. The JAVA code reads in a JSON file and writes a .docx (Microsoft, 2024) file based on the JSON. It uses Apache POI (The Apache Software Foundation, 2023) for writing data to a .docx file. The PYTHON code converts this .docx file into a PDF using, for example, the “docx2pdf” project (Johri, 2021), and then converts this PDF into an image file using, for example, the ‘pdf2image″ project (Belval, 2024).

Currently, in order to get training data for a document-parsing AI, one may either manually parse a document into JSON, use pre-made configuration files to parse a document into JSON, or use an external dataset. Manually parsing a document into JSON is time consuming. Relying on pre-made configuration files is another way, but sometimes text cannot be extracted from a PDF, meaning some documents cannot be parsed into JSON correctly. Also, after a document is parsed using a configuration file, it should be manually checked, which is also time consuming. Furthermore, in order to get a specific data variation, such as a unique way of writing a table, one will have to find a pre-existing document with that variation, and then update the configuration file(s) and possibly the parsing code in order to have data that captures that variation. By using this synthetic data generation system, one can increase the amount of data in the world that can be used to parse a document. A pre-existing database may parse certain objects into JSON using a JSON format that one would rather not use, but one will not have this problem if one is creating the documents and JSON parsing ourselves. Also, with disclosed embodiments, one might not worry about noise in the data, since because the document is created by a user, the user may be aware of how it should be parsed. Furthermore, disclosed embodiments provide for data variation to be introduced into the dataset since one can create a document with that variation built in.

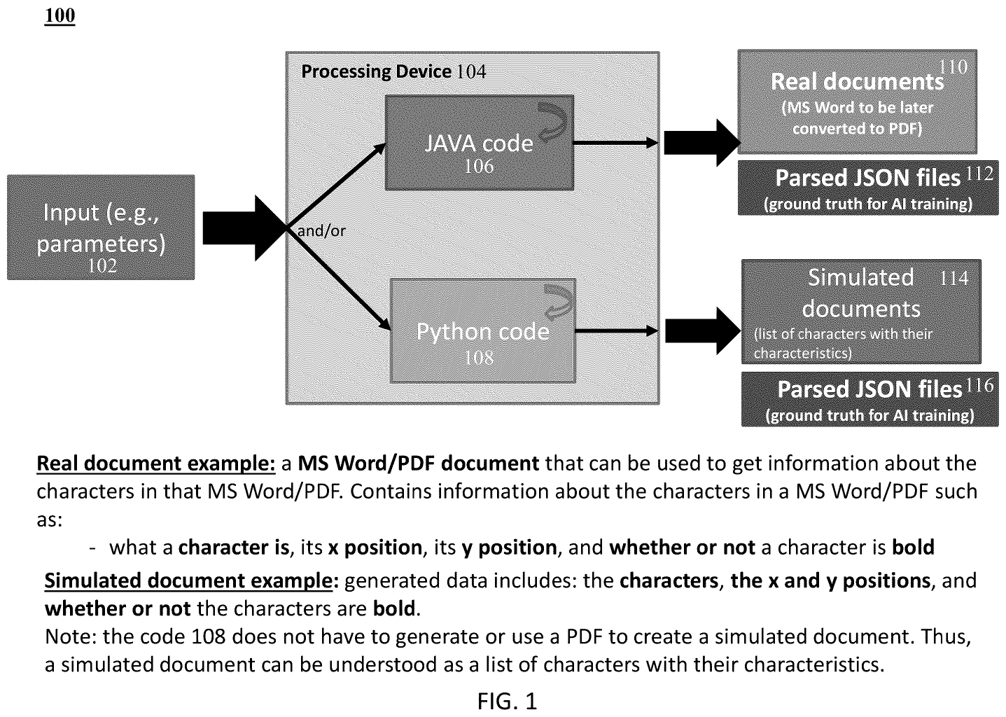

FIG. 1 illustrates a schematic block diagram of an exemplary system 100 for creating training, testing, and validation data for an artificial intelligence system to use for training and evaluation purposes in order to parse a document.

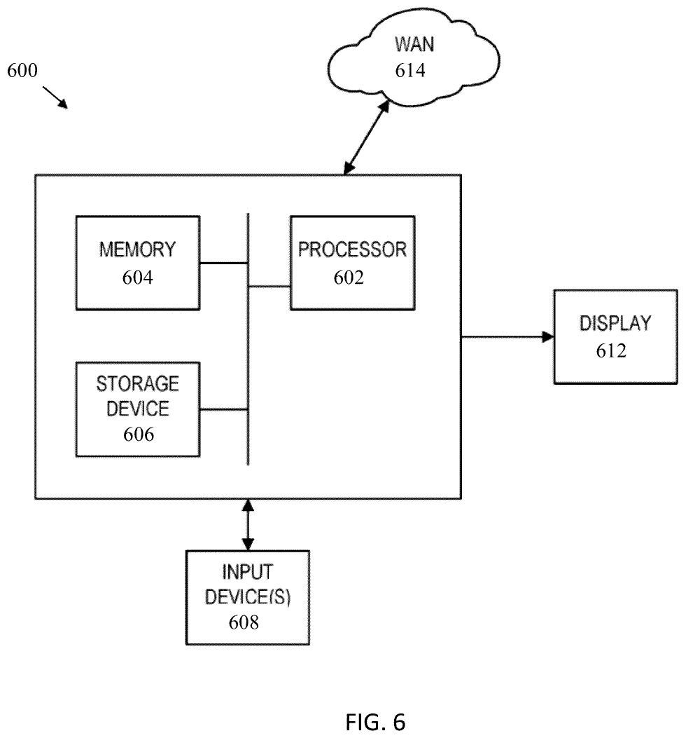

The system 100 may include a processing device 104. In some cases, the processing device 104 may be or be part of a computer system (e.g., such as shown in FIG. 6 and described herein).

As shown in FIG. 1, the processing device 104 may receive an input 102, such as from a user or hardcoded to use in the process. The input 102 may include one or more parameters or characteristics, such as locational data, font data, or the like. The input 102 may be received and processed by a JAVA data structure (e.g., code) 106 on the processing device 104. The JAVA code 106 may generate one or more non-simulated documents (e.g., real document 110) based on the input 102. The non-simulated document 110 may be a word-processing formatted document. The non-simulated document 110 may be used to get information about the characters in that document, and may contain information about the characters in a MS Word/PDF such as: what a character is, its x position, its y position, and whether or not a character is bold. Other parameters may be used in some embodiments. A parsed JSON file 112 may also be produced and be used for training an AI system, such as described further herein. In some embodiments, the code 106 may be a different type of code other than JAVA code.

The input 102 may be received and processed by the PYTHON code 108 on processing device 104. The PYTHON data structure (e.g., code) 108 may generate one or more simulated documents 114, which may contain a list of one or more characters with one or more associated characteristics. The generated data on the simulated document 114 may include the character(s), the x and y positions, and whether or not the characters are bold. In some cases, the code 108 might not have to generate or use a PDF to create a simulated document, where a simulated document can be understood as a list of characters with their characteristics. A parsed JSON file 116 may also be produced and be used for training an AI system, such as described herein. In some embodiments, the code 108 may be a different type of code other than PYTHON code.

The generated documents can be used for training, validation, and testing data for an artificial intelligence system that can convert a document into a JSON representation of that document. In some cases, disclosed aspects may randomly create real or simulated documents. In some cases, each document may include a random selection of pre-defined objects (such as various KeyValuePair objects). In some cases, each object may be associated with one or more characteristics (such as how many rows does a table have) and strings, where the characteristics and/or strings may be random.

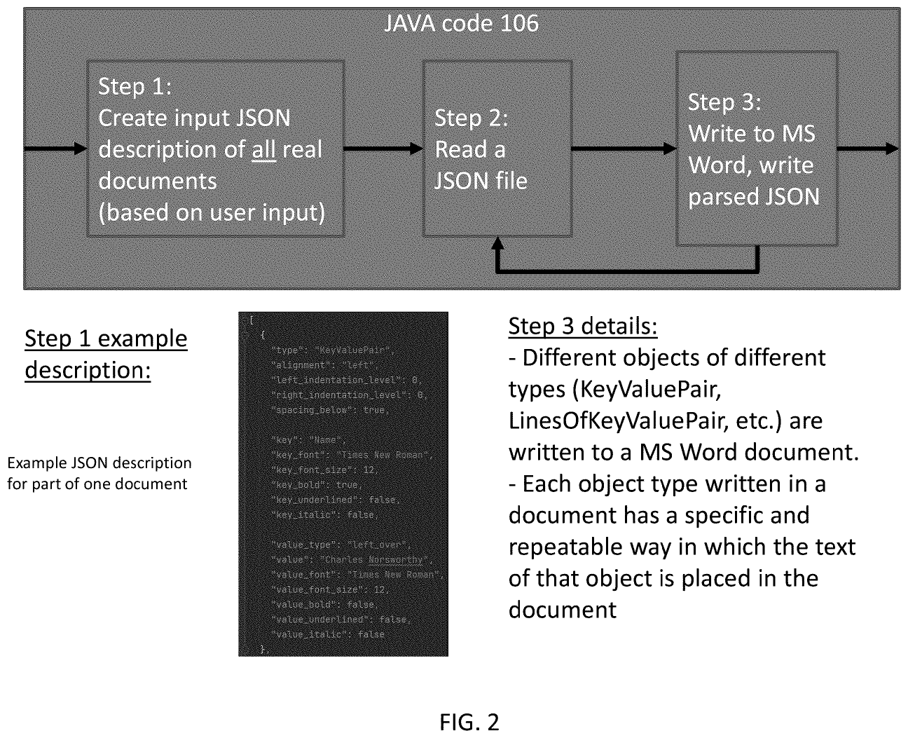

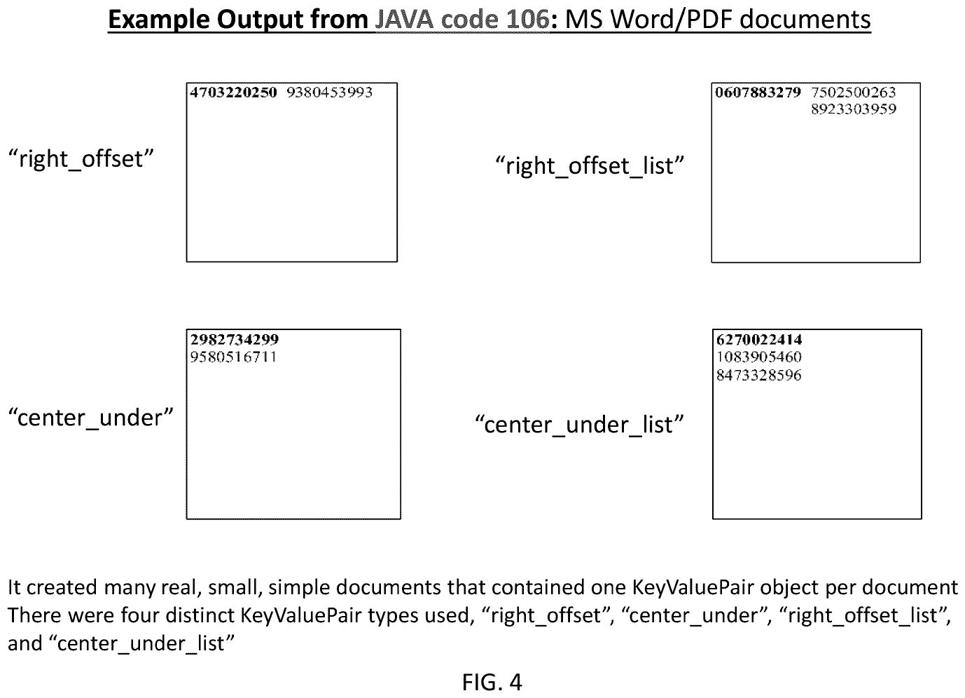

FIG. 2 illustrates a block diagram of an exemplary JAVA data structure 106 for creating training, testing, and validation data for an artificial intelligence system to use for training and evaluation purposes in order to parse a document. As shown, step 1 of 106 may include generating, via the JAVA data structure, a non-parsed JSON file comprising a description for a non-simulated document based on the set of one or more parameters (e.g., user input, hard-coded, etc.). Step 2 of 106 may include reading the JSON file. Step 3 of 106 may include generating a word-processing format file comprising a first set of one or more objects, each object of the first set being associated with a respective object type, where each object type in the first set corresponds to a specific and repeatable manner in which associated text of that object is placed in the non-simulated document. One or more steps can be repeated and/or provided as feedback to any other step. Example output from the JAVA code 106 can be shown in FIG. 4. An example JSON description for part of a document is shown below:

```
[
  {
    ″type″: ″KeyValuePair″,
    ″alignment″: ″left″,
    ″left_indentation_level″: 0,
    ″right_indentation_level″: 0,
    ″spacing_below″: true,
    ″key″: ″Name″,
    ″key_font″: ″Times New Roman″,
    ″key_font_size″: 12,
    ″key_bold″: true,
    ″key_underlined″: false,
    ″key_italic″: false,
    ″value_type″: ″left_over″,
    ″value″: ″Charles Norsworthy″,
    ″value_font″: ″Times New Roman″,
    ″value_font_size″: 12,
    ″value_bold″: false,
    ″value_underlined″: false,
    ″value_italic″: false
  },
```

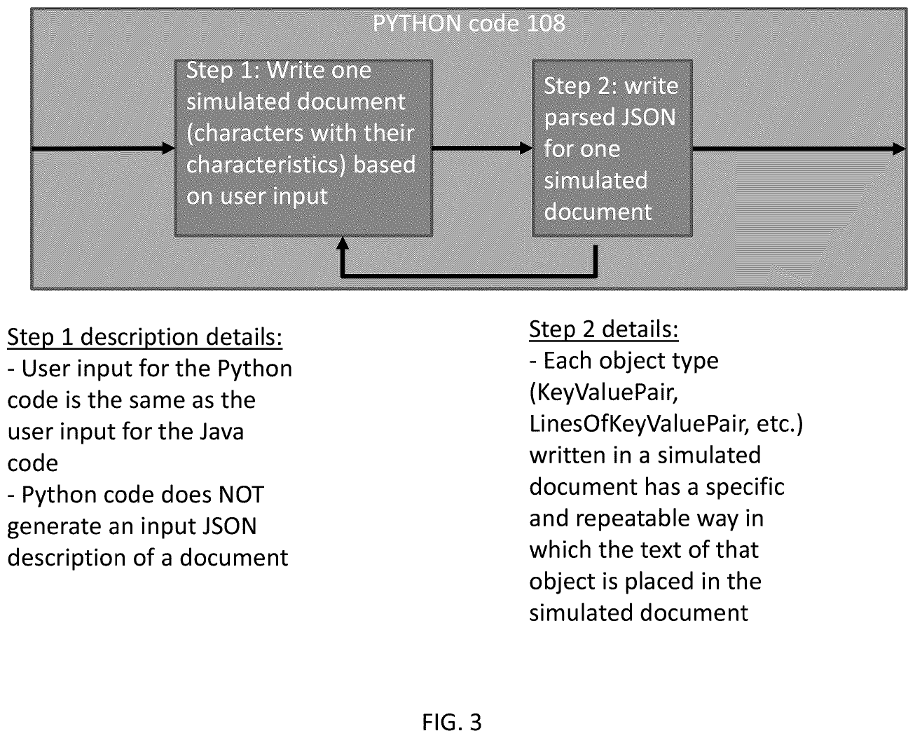

FIG. 3 illustrates a block diagram of an exemplary PYTHON data structure 108 for creating training, testing, and validation data for an artificial intelligence system to use for training and evaluation purposes in order to parse a document. As shown, step 1 of 108 may include generating, via the PYTHON data structure and based on the set of one or more parameters, a simulated document comprising a list of one or more characters associated with one or more respective characteristics. Step 2 of 108 may include generating a parsed JSON file for the simulated document comprising a second set of one or more objects, each object in the second set being associated with a respective object type, where each object type corresponds to a specific and repeatable manner in which associated text of that object is placed in the simulated document. One or more steps can be repeated and/or provided as feedback to any other step.

Exemplary implementations in accordance with disclosed aspects:

### 1.1 Document Objects

In an example, a document that can be used in training is constructed by combining pre-defined objects together. According to some aspects, in one example, there may be seven objects which can be used to construct a document: KeyValuePair, LinesOfKey ValuePair, Table, Paragraph, ParagraphRow, Header, and Footer. Other objects may be used in some cases.

### 1.2 Document Object Attributes

Objects that are written to a document can have many attributes.

### 1.2.1 Lines Above and Below

These objects have the option of having a line above the object or above the object's label if it exists, or a line below the object, or both. Objects that exist within other objects do not have the option to have these lines in some cases. This includes KeyValuePair objects that exist within in a LinesOfKeyValuePair object. The objects that exist within an indented object list also might not have the option to have these lines in some cases.

### 1.2.2 Alignment

Objects have three options for how they are aligned: left, center, and right. The KeyValuePair objects present in a LinesOfKeyValuePair object do not have the option to be aligned left, center, or right in some cases.

### 1.2.3 Indentation

Objects have the option to be placed in the document at a specified left or right indentation level. Each successive indentation level is some previously defined distance away from the previous indentation level. The KeyValuePair objects in a LinesOfKey ValuePair object do not have the option for a left or right indentation level in some cases. The KeyValuePair, LinesOfKey ValuePair, Table, and ParagraphRow objects do not have the option to have a right or left indentation level if they are aligned right or center in the document in some cases. This is because these objects are all tables in a MICROSOFT WORD (Microsoft, 2024) document. The Paragraph objects also have the option to have either a hanging indent or a first line indent.

### 1.2.4 Label

All objects have the option for a label to be placed above the object. This label is always in bold, and can be aligned left, center, or right in the document. A label can also have a left or right indentation level in the document. A label can consist of multiple paragraphs.

### 1.2.5 Indented Object List

The indented object list attribute lets any object have an indented list of objects associated with it. Each object in an indented object list can itself have another indented object list associated with it. Any object except Header or Footer objects can be in an indented object list. In the parsed JSON for an object with an indented object list, the parsed JSON data for each object in an indented object list is placed in its own JSON object, and each of these JSON objects is placed in a JSON array, and this JSON array is included in the parsed JSON for the original object.

### 1.3 Object Types

### 1.3.1 KeyValuePair

The KeyValuePair object has different value types. There are two different categories of value types. The “one_string” category is composed of value types that have one string for the value. The “multiple_string” category is composed of value types that have multiple strings for the value.

Checkbox characters are characters that are meant to be interpreted as a Boolean value in the parsed JSON. Thus, there are two types of checkbox characters: characters that are meant to be interpreted as false, and characters that are meant to be interpreted as true. An unselected checkbox is associated with false, and a selected checkbox is associated with true. If a KeyValuePair has one string for its value, this string can be a checkbox character. If a KeyValuePair has a list of strings for its value, any string in this list can be a checkbox character.

The checkbox characters associated with the false Boolean value are:
1. “BALLOT BOX” (U+2610), “□”. (Unicode Consortium, n.d.a)
2. “WHITE SQUARE” (U+25A1), “□”. (Unicode Consortium, n.d.a)

The checkbox characters associated with the true Boolean value are:
1. “BALLOT BOX WITH X” (U+2612), “ [symbol] ”. (Unicode Consortium, n.d.a)
2. “BALLOT BOX WITH LIGHT X” (U+2BBD), “ [symbol] ”. (Unicode Consortium, n.d.a)
3. “BALLOT BOX WITH CHECK” (U+2611), “ [symbol] ”. (Unicode Consortium, n.d.a)
4. “WHITE SQUARE CONTAINING BLACK SMALL SQUARE” (U+25A3), “ [symbol] ”. (Unicode Consortium, n.d.b).

### 1.3.1.1 Category: “One_String”

With the “left_offset” value type, the value is one string to the left of the key.
Charles Norsworthy Name

With the “right_offset” value type, the value is one string to the right of the key.
Name Charles Norsworthy

With the “left_over” value type, the value is one string placed above the key and aligned to the left of the key.
Charles Norsworthy
Name

With the “center_over” value type, the value is one string centered above the key.
Charles Norsworthy
Name

With the “right_over” value type, the value is one string placed above the key and aligned to the right of the key.
Charles Norsworthy
Name

With the “left_under” value type, the value is one string under the key and aligned to the left of the key.
Name
Charles Norsworthy

With the “center_under” value type, the value is one string centered under the key.
Name
Charles Norsworthy

With the “right_under” value type, the value is one string under the key, and this value is aligned to the right of the key.
Name
Charles Norsworthy
   1.3.1.2 Category: “multiple_strings”

With the “left_offset_list” value type, the value is a list of strings to the left of the key. Each string in this list of strings is placed under the first string in the list and is aligned to the right of the first string in the list.
Charles Name
Norsworthy

[symbol]

With the “left_offset_right_under_list” value type, the value is a list of strings. The first string in this list is placed to the left of the key, and the rest of the strings in this list are placed under the key and are aligned to the right of the key.
Charles Name
Norsworthy

[symbol]

With the “right_offset_list” value type, the value is a list of strings to the right of the key. Each string in this list of strings is placed under the first string in the list and is aligned to the left of the first string in the list.
Name Charles
Norsworthy

[symbol]

With the “right_offset_left_under_list” value type, the value is a list of strings. The first string in this list is placed to the right of the key, and the rest of the strings in this list are placed under the key and are aligned to the left of the key.
Name Charles
Norsworthy

[symbol]

With the “left_over_list” value type, the value is a list of strings above the key. Each string in this list of strings is aligned to the left of the key.
Charles
Norsworthy [symbol]
Name

With the “center_over_list” value type, the value is a list of strings centered above the key.
Charles
Norsworthy [symbol]
Name

With the “right_over_list” value type, the value is a list of strings above the key. Each string in this list of strings is aligned to the right of the key.
Charles
Norsworthy [symbol]
Name

With the “left_under_list” value type, the value is a list of strings aligned left under the key.
Name
Charles
Norsworthy

[symbol]

With the “center_under_list” value type, the value is a list of strings centered under the key.
Name
Charles
Norsworthy

[symbol]

With the “right_under_list” value type, the value is a list of strings under the key, and all strings in this list are aligned to the right of the key.
Name
Charles
Norsworthy

[symbol]

### 1.3.2 LinesOfKeyValuePair

The LinesOfKeyValuePair object consists of one or more lines of one or more KeyValuePair objects. These KeyValuePair objects may be of any value type. This object's data except for the label is placed in a Microsoft Word document table with its borders removed. The LinesOfKey ValuePair object is inspired by data found in FAA forms.

A LinesOfKeyValuePair object is shown below, where this object has a label.

Example

| | | |
|---|---|---|
| Name1 | Name2 | Name3 |
| Charles Norsworthy | Charles Norsworthy | Charles Norsworthy |
| Name1 | Name2 | Name3 |
| Charles Norsworthy | Charles Norsworthy | Charles Norsworthy |

### 1.3.3 Paragraph

A Paragraph object is text that is placed in the document. This text can span several lines in the document. Each Paragraph object may be preceded by a delimiter that denotes that a new Paragraph object is present. This delimiter can be many things, including a number, a Roman numeral, a letter, or a character such as “-”. Numbers, Roman numerals, and letters may be followed by a period “.”. A space is placed between a delimiter and the paragraph text, or between the period after the delimiter and the paragraph text.

A Paragraph object with a label is seen below.

### EXAMPLE

This is a paragraph

### 1.3.4 Table

A Table object is a table in a Microsoft Word document.

In the image below, “Table 1” presents a Table object that contains a label.

TABLE 1

| header1 | header2 | header3 |
|---|---|---|
| value1_1 | value1_2 | value1_3 |
| value2_1 | value2_2 | value2_3 |

In the image below, one can also see that it can be specified that a table not have any internal vertical borders (“Table 2”), any internal horizontal borders (“Table 3”), or any outside border (“Table 4”). Also, any combination of these three options can be specified.

TABLE 2

| header1 | header2 | header3 |
|---|---|---|
| value1_1 | value1_2 | value1_3 |
| value2_1 | value2_2 | value2_3 |

TABLE 3

| header1 | header2 | header3 |
|---|---|---|
| value1_1 | value1_2 | value1_3 |
| value2_1 | value2_2 | value2_3 |

TABLE 4

| header1 | header2 | header3 |
|---|---|---|
| value1_1 | value1_2 | value1_3 |
| value2_1 | value2_2 | value2_3 |

Tables have the option of not having header rows (“Table 5”).

TABLE 5

| | | |
|---|---|---|
| value1_1 | value1_2 | value1_3 |
| value2_1 | value2_2 | value2_3 |

In “Table 6” in the image below, headers contain multiple lines of text. In the parsed JSON for this table, these multiple lines of text are combined into one line of text.

TABLE 6

| This is | This is |
|---|---|
| header1 | header2 |
| value1 | value2 |

In “Table 7” in the image below, certain headers in the header row have different characteristics than what is specified for all headers. Also, certain elements in the value row have different characteristics than what is specified for all values.

TABLE 7

| header1 | header2 | header3 |
|---|---|---|
| value1 | value2 | value3 |

In “Table 1” in the image below, the Table object contains two header rows instead of one. This table is based on the “Category” table from FAA forms such as in source (U.S. Department of Transportation, 2022).

TABLE 1

| header1_1 | header1_2 | | | header1_3 | | |
|---|---|---|---|---|---|---|
| header2_1 | header2_2 | header2_3 | header2_4 | header2_2 | header2_3 | header2_4 |
| value1_1 | value1_2 | value1_3 | value1_4 | value1_5 | value1_6 | value1_7 |
| value2_1 | value2_2 | value2_3 | value2_4 | value2_5 | value2_6 | value2_7 |

In “Table 2” in the image below, the Table object contains three header rows. None of the headers in a row are repeated.

TABLE 2

| header1 | | | | | header2 | | | | |
|---|---|---|---|---|---|---|---|---|---|
| header1-1 | | | header1-2 | | header2-1 | | | header2-2 | |
| header1-1-1 | header1-1-2 | header1-1-3 | header1-2-1 | header1-2-2 | header2-1-1 | header2-1-2 | header2-1-3 | header2-2-1 | header2-2-2 |
| value1-1 | value1-2 | value1-3 | value1-4 | value1-5 | value1-6 | value1-7 | value1-8 | value1-9 | value1-10 |
| value2-1 | value2-2 | value2-3 | value2-4 | value2-5 | value2-6 | value2-7 | value2-8 | value2-9 | value2-10 |

In “Table 3” in the image below, the Table object contains three header rows, but in two of the header rows, headers are repeated.

TABLE 3

| header1 | | | | | header2 | | | | |
|---|---|---|---|---|---|---|---|---|---|
| header1-1 | | | header1-2 | | C | | | C | |
| A | B | A | A | B | A | B | A | A | A |
| value1-1 | value1-2 | value1-3 | value1-4 | value1-5 | value1-6 | value1-7 | value1-8 | value1-9 | value1-10 |
| value2-1 | value2-2 | value2-3 | value2-4 | value2-5 | value2-6 | value2-7 | value2-8 | value2-9 | value2-10 |

In “Table 4” in the image below, there are two header rows, but the first header row only has one header (or more in some embodiments), and this header is a super header for only two of the headers on the second header row (or more in some embodiments). This table is inspired by “TBL 4-1-1” in information provided by the FAA (U.S. Department of Transportation, 2023a).

TABLE 4

| | | | header | |
|---|---|---|---|---|
| A | B | C | D | E |
| value1-1 | value1-2 | value1-3 | value1-4 | value1-5 |
| value2-1 | value2-2 | value2-3 | value2-4 | value2-5 |

### 1.3.4.1 Table Characteristic: “Repeated_Headers”

With the “repeated_headers” characteristic, a table has at least one header that is placed two or more times in a header row. In the parsed JSON for tables with this characteristic, the values in a value row in the table are placed into JSON objects in a JSON array, with each JSON object in this array containing key value pairs such that there is not a duplicate key in that object.

There is an algorithm for computing the headers that will appear in each JSON object in a JSON array representing one value row. This algorithm adds headers to a header group until it encounters a header that will produce a duplicate in that group. Then it starts a new group with that header being the first header of this new group. It continues to process headers like this until there are no more headers to process.

In “Table 1” in the image below, the table has these headers: A, B, C, A, B, C. This table has three unique core headers: A, B, and C. These three headers are placed twice in the header row.

TABLE 1

| A | B | C | A | B | E |
|---|---|---|---|---|---|
| row2_column1 | row2_column2 | row2_column3 | row2_column4 | row2_column5 | row2_column6 |
| row3_column1 | row3_column2 | row3_column3 | row3_column4 | row3_column5 | row3_column6 |

In “Table 2” in the image below, the table has these headers: A, B, C, A, D, E. This table has five unique core headers: A, B, C, D, and E. Only the “A” header is repeated in this case.

TABLE 2

| A | B | C | A | D | E |
|---|---|---|---|---|---|
| row2_column1 | row2_column2 | row2_column3 | row2_column4 | row2_column5 | row2_column6 |
| row3_column1 | row3_column2 | row3_column3 | row3_column4 | row3_column5 | row3_column6 |

### 1.3.4.2 Table Characteristic: “Object_Values”

A Table with the “object_values” characteristic is a Table in which one or more of the cells in the value rows contain one or more objects instead of one or more Paragraph strings. These objects can be of any type and have any characteristic, including having a nested object list. In a value cell, there can be several objects. Objects in a table cell do not have the option to have a line above or a line below the object in some cases.

In “Table 1” in the image below, the first cell in the first value row contains a list of two objects: a KeyValuePair object, and a Paragraph object. The second cell in the first value row contains a LinesOfKeyValuePair object. The third cell in the first value row contains a Paragraph object. The fourth cell in the first value row contains a Table object with an indented object list. The second value row simply contains one string in each cell.

TABLE 1
header1
Name
Charles Norsworthy
This is a paragraph in
cell 1.
value2-1
header2

| | |
|---|---|
| Name1 Charles | Name2 |
| Norsworthy | Charles |
| | Norsworthy |
| Name1 [symbol] | Name2 [symbol] |

value2-2
header3

This is a paragraph in
cell 3.

value2-3
header4
Value Table

| A | B | C |
|---|---|---|
| value1_1 | value1_2 | value1_3 |
| value2_1 | value2_2 | value2_3 |

This is an indented paragraph in
cell 4.
Left Indentation
Level: 2

value2-4

### 1.3.4.3 Table Characteristic: “Combined_Value_Cells”

A Table with the “combined_value_cells” characteristic is a Table in which one or more of the cells in the table have been combined with another cell in the table above, or below, or to the left, or to the right of the cell. When cells are combined horizontally, the value in the combined cell is associated with the headers for the cells that have been combined. When cells are combined vertically, the value rows containing the cells that have been combined all share the value in the combined cell. When cells are combined both horizontally and vertically, both of the two above sentences are true.

In “Table 1” in the image below, the first two cells of the first value row have been combined, and the last two cells of the second value row have been combined.

TABLE 1

| | | | |
|---|---|---|---|
| header1 | header2 | header3 | header4 |

| | | |
|---|---|---|
| value_1-1 | value_1-2 | value_1-3 |

| | | |
|---|---|---|
| value_2-1 | value_2-2 | value_2-3 |

In “Table 2” in the image below, the cells in the first column and the cells in the last column of the value rows have been combined.

TABLE 2

| header1 | header2 | header3 | header4 |
|---|---|---|---|
| combined_value_1 | value_1-1 | value_1-2 | combined_value_2 |
| | value_2-1 | value_2-2 | |

In “Table 3” in the image below, the cells from (1, 1) to (2, 2) have been combined diagonally.

TABLE 3

| header1 | header2 | header3 | header4 |
|---|---|---|---|
| value_1-1 | value_1-2 | value_1-3 | value_1-4 |
| value_2-1 | combined_value | | value_2-4 |
| value_3-1 | | | value_3-4 |
| value_4-1 | value_4-2 | value_4-3 | value_4-4 |

In “Table 4” in the image below, all the value cells in the only value row have been combined.

TABLE 4

| | | | |
|---|---|---|---|
| header1 | header2 | header3 | header4 |

value_1-1

### 1.3.4.4 Table Characteristic: “Combined_Header_Cells”

A Table with the “combined_header_cells” characteristic is a Table in which one or more of the cells in the header rows have been combined with another cell in the header rows above, or below, or to the left, or to the right of the cell.

In “Table 1” in the image below, the cells in the first two header cells are horizontally combined. This means that this header relates to the two value columns.

TABLE 1

| header1 | | header2 | header3 |
|---|---|---|---|
| value1_1 | value1_2 | value1_3 | value1_4 |
| value2_1 | value2_2 | value2_3 | value2_4 |

In “Table 2” in the image below, the cells in the first header column are vertically combined.

TABLE 2

| | header1_2 | | |
|---|---|---|---|
| header1 | header2_1 | header2_2 | header2_3 |
| value1_1 | value1_2 | value1_3 | value1_4 |
| value2_1 | value2_2 | value2_3 | value2_4 |

In “Table 3” in the image below, the table object is the same as the previous “Table 2”, except that the last two cells in the second header row have been combined and now have one header for both cells.

TABLE 3

| | header1_2 | | |
|---|---|---|---|
| header 1 | header2_1 | header2_2 | |
| value1_1 | value1_2 | value1_3 | value1_4 |
| value2_1 | value2_2 | value2_3 | value2_4 |

In “Table 4” in the image below, the table object has the first header cell diagonally merged.

TABLE 4

| | | header1_2 | |
|---|---|---|---|
| header1 | | header2_1 | header2_2 |
| value1_1 | value1_2 | value1_3 | value1_4 |
| value2_1 | value2_2 | value2_3 | value2_4 |

In “Table 5” in the image below, the table object has two header groups in its one header row, and these header groups contain cells that have been combined.

TABLE 5

| A | | B | A | B | |
|---|---|---|---|---|---|
| value1_1 | value1_2 | value1_3 | value1_4 | value1_5 | value1_6 |
| value2_1 | value2_2 | value2_3 | value2_4 | value2_5 | value2_6 |

In “Table 6” in the image below, the table object has three header rows with headers that are diagonally and vertically combined.

TABLE 6

| header1 | | |
|---|---|---|
| header3_1 | header3_2 | header2 |
| value1_1 | value1_2 | value1_3 |
| value2_1 | value2_2 | value2_3 |

In “Table 7” in the image below, the table object has three header rows with headers that are diagonally, horizontally, and vertically combined.

TABLE 7

| header1 | | | |
|---|---|---|---|
| header3_1 | header3_2 | | header2 |
| value1_1 | value1_2 | value1_3 | value1_4 |
| value2_1 | value2_2 | value2_3 | value2_4 |

### 1.3.4.5 Table Characteristic: “Sub_Labels”

A Table with the “sub_labels” characteristic is a Table in which there are rows in which all cells in the row are merged horizontally together, and there is one bold header in this combined cell. This header is a sub label. This header acts like a label for the Table values until either the Table values end or until the next sub label.

In “Table 1” in the image below, a Table object is presented that has a single sub label.

TABLE 1

| header1 | header2 |
|---|---|
| value1 | value2 |

Label A

| | |
|---|---|
| value_a_1 | value_a_2 |

In “Table 2” in the image below, a Table object is presented that has two sub labels.

TABLE 2

| header1 | header2 |
|---|---|
| value1 | value2 |

Label A

| | |
|---|---|
| value_a_1 | value_a_2 |
| value_a_3 | value_a_4 |

Label B

| | |
|---|---|
| value_b_1 | value_b_2 |
| value_b_3 | value_b_4 |

### 1.3.4.6 Table Subtype: “Key_Value_Pair”

A Table of the “key_value_pair” subtype is a Table that is composed of a collection of key value pairs inside the table. A key is placed in one cell, and the value for this key is placed in another cell. The keys are in bold, and the values are not in bold. A value can be one string or a list of strings. If key value pair has one string for its value, this string can be any one of the checkbox characters. If a key value pair has a list of strings for its value, any string in this list can be any one of the checkbox characters.

There are currently four categories of Table objects for the “key_value_pair” Table subtype. The Table category is determined by where the value for a key is placed. With the “right_offset” key value pair table category, the value for a key is placed in the cell to the right of this key. With the “center_under” key value pair table category, the value for a key is placed in the cell below this key. With the “left_offset” key value pair table category, the value for a key is placed in the cell to the left of this key. With the “center_over” key value pair table category, the value for a key is placed in the cell below this key.

### 1.3.4.6.1 Category: “Right_Offset”

In “Table 1” in the image below, a Table object of the “key_value_pair” Table subtype and of the “right_offset” key value pair table category is presented without a header row.

TABLE 1

| | | | | | | | |
|---|---|---|---|---|---|---|---|
| Key1 | row1_column2_value | Key2 | [symbol] | Key3 | row1_column6_value1 | Key4 | row1_column8_value1 |
| | | | | | row1_column6_value2 | | row1_column8_value2 |
| | | | | | | | [symbol] |
| Key5 | row2_column2_value | Key6 | [symbol] | Key7 | row2_column6_value1 | Key8 | row2_column8_value1 |
| | | | | | row2_column6_value2 | | row2_column8_value2 |
| | | | | | | | [symbol] |

In “Table 2” in the image below, “Table 1” is presented, except with a header row. In this table, every header is unique.

TABLE 2

| A | B | C | D | E | F | G | H |
|---|---|---|---|---|---|---|---|
| Key1 | row1_column2_value | Key2 | [symbol] | Key3 | row1_column6_value1 | Key4 | row1_column8_value1 |
| | | | | | row1_column6_value2 | | row1_column8_value2 |
| | | | | | | | [symbol] |
| Key5 | row2_column2_value | Key6 | [symbol] | Key7 | row2_column6_value1 | Key8 | row2_column8_value1 |
| | | | | | row2_column6_value2 | | row2_column8_value2 |
| | | | | | | | [symbol] |

In “Table 3” in the image below, “Table 1” is presented, except with a header row. In this table, there are four core headers: A, B, C, and D. Each header is repeated twice in the header row.

TABLE 3

| A | B | C | D | A | B | C | D |
|---|---|---|---|---|---|---|---|
| Key1 | row1_column2_value | Key2 | [symbol] | Key3 | row1_column6_value1 | Key4 | row1_column8_value1 |
| | | | | | row1_column6_value2 | | row1_column8_value2 |
| | | | | | | | [symbol] |
| Key5 | row2_column2_value | Key6 | [symbol] | Key7 | row2_column6_value1 | Key8 | row2_column8_value1 |
| | | | | | row2_column6_value2 | | row2_column8_value2 |
| | | | | | | | [symbol] |

In “Table 4” in the image below, “Table 1” is presented, except with a header row. In this table, there are two core headers: A and B. These headers are repeated multiple times in the header row.

TABLE 4

| A | B | A | B | B | A | A | B |
|---|---|---|---|---|---|---|---|
| Key1 | row1_column2_value | Key2 | [symbol] | Key3 | row1_column6_value1 | Key4 | row1_column8_value1 |
| | | | | | row1_column6_value2 | | row1_column8_value2 |
| | | | | | | | [symbol] |
| Key5 | row2_column2_value | Key6 | [symbol] | Key7 | row2_column6_value1 | Key8 | row2_column8_value1 |
| | | | | | row2_column6_value2 | | row2_column8_value2 |
| | | | | | | | [symbol] |

1.3.4.6.2 Category: “center_under”

In “Table 1” in the image below, a Table object of the “key_value_pair” Table subtype and of the “center_under” key value pair table category is presented without a header row.

TABLE 1

| Key1 | Key2 | Key3 | Key4 |
|---|---|---|---|
| row2_column1_ | [symbol] | row2_column3_value1 | row2_column4_value1 |
| value | | row2_column3_value2 | row2_column4_value2 |
| | | | [symbol] |
| Key5 | Key6 | Key7 | Key8 |
| row4_column1_ | [symbol] | row4_column3_value1 | row4_column4_value1 |
| value | | row4_column3_value2 | row4_column4_value2 |
| | | | [symbol] |

In “Table 2” in the image below, “Table 1” is presented, except with a header row. In this table, every header is unique.

TABLE 2

| A | B | C | D |
|---|---|---|---|
| Key1 | Key2 | Key3 | Key4 |
| row2_column1_ | [symbol] | row2_column3_value1 | row2_column4_value1 |
| value | | row2_column3_value2 | row2_column4_value2 |
| | | | [symbol] |
| Key5 | Key6 | Key7 | Key8 |
| row4_column1_ | [symbol] | row4_column3_value1 | row4_column4_value1 |
| value | | row4_column3_value2 | row4_column4_value2 |
| | | | [symbol] |

In “Table 3” in the image below, “Table 1” is presented, except with a header row. In this table, there are two core headers: A and B. Each header is repeated twice in the header row.

TABLE 3

| A | B | A | B |
|---|---|---|---|
| Key1 | Key2 | Key3 | Key4 |
| row2 column1_ | [symbol] | row2_column3_value1 | row2_column4_value1 |
| value | | row2_column3_value2 | row2_column4_value2 |
| | | | [symbol] |
| Key5 | Key6 | Key7 | Key8 |
| row4_column1_ | [symbol] | row4_column3_value1 | row4_column4_value1 |
| value | | row4_column3_value2 | row4_column4_value2 |
| | | | [symbol] |

In “Table 4” in the image below, “Table 1” is presented, except with a header row. In this table, there are two core headers: A and B. Only the “A” header is repeated in the header row in this case.

TABLE 4

| A | B | A | A |
|---|---|---|---|
| Key1 | Key2 | Key3 | Key4 |
| row2_column1_ | [symbol] | row2_column3_value1 | row2_column4_value1 |
| value | | row2_column3_value2 | row2_column4_value2 |
| | | | [symbol] |
| Key5 | Key6 | Key7 | Key8 |
| row4_column1_ | [symbol] | row4_column3_value1 | row4_column4_value1 |
| value | | row4_column3_value2 | row4_column4_value2 |
| | | | [symbol] |

### 1.3.4.6.3 Category: “Left_Offset”

In “Table 1” in the image below, a Table object of the “key_value_pair” Table subtype and of the “left_offset” key value pair table category is presented without a header row.

TABLE 1

| | | | | | | | |
|---|---|---|---|---|---|---|---|
| row1_column2_value | Key1 | [symbol] | Key2 | row1_column6_value1 | Key3 | row1_column8_value1 | Key4 |
| | | | | row1_column6_value2 | | row1_column8_value2 | |
| | | | | | | [symbol] | |
| row2_column2_value | Key5 | [symbol] | Key6 | row2_column6_value1 | Key7 | row2_column8_value1 | Key8 |
| | | | | row2_column6_value2 | | row2_column8_value2 | |
| | | | | | | [symbol] | |

In “Table 2” in the image below, “Table 1” is presented, except with a header row. In this table, every header is unique.

TABLE 2

| A | B | C | D | E | F | G | H |
|---|---|---|---|---|---|---|---|
| row1_column2_value | Key1 | [symbol] | Key2 | row1_column6_value1 | Key3 | row1_column8_value1 | Key4 |
| | | | | row1_column6_value2 | | row1_column8_value2 | |
| | | | | | | [symbol] | |
| row2_column2_value | Key5 | [symbol] | Key6 | row2_column6_value1 | Key7 | row2_column8_value1 | Key8 |
| | | | | row2_column6_value2 | | row2_column8_value2 | |
| | | | | | | [symbol] | |

In “Table 3” in the image below, “Table 1” is presented, except with a header row. In this table, there are four core headers: A, B, C, and D. Each header is repeated twice in the header row.

TABLE 3

| A | B | C | D | A | B | C | D |
|---|---|---|---|---|---|---|---|
| row1_column2_value | Key1 | [symbol] | Key2 | row1_column6_value1 | Key3 | row1_column8_value1 | Key4 |
| | | | | row1_column6_value2 | | row1_column8_value2 | |
| | | | | | | [symbol] | |
| row2_column2_value | Key5 | [symbol] | Key6 | row2_column6_value1 | Key7 | row2_column8_value1 | Key8 |
| | | | | row2_column6_value2 | | row2_column8_value2 | |
| | | | | | | [symbol] | |

In “Table 4” in the image below, “Table 1” is presented, except with a header row. In this table, there are two core headers: A and B. These headers are repeated multiple times in the header row.

TABLE 4

| A | B | A | B | B | A | A | B |
|---|---|---|---|---|---|---|---|
| row1_column2_value | Key1 | [symbol] | Key2 | row1_column6_value1 | Key3 | row1_column8_value1 | Key4 |
| | | | | row1_column6_value2 | | row1_column8_value2 | |
| | | | | | | [symbol] | |
| row2_column2_value | Key5 | [symbol] | Key6 | row2_column6_value1 | Key7 | row2_column8_value1 | Key8 |
| | | | | row2_column6_value2 | | row2_column8_value2 | |
| | | | | | | [symbol] | |

### 1.3.4.6.4 Category: “Center_Over”

In “Table 1” in the image below, a Table object of the “key_value_pair” Table subtype and of the “center_over” key value pair table category is presented without a header row.

TABLE 1

| | | | |
|---|---|---|---|
| row2_column1_ | [symbol] | row2_column3_value1 | row2_column4_value1 |
| value | | row2_column3_value2 | row2_column4_value2 |
| | | | [symbol] |
| Key1 | Key2 | Key3 | Key4 |
| row4_column1_ | [symbol] | row4_column3_value1 | row4_column4_value1 |
| value | | row4_column3_value2 | row4_column4_value2 |
| | | | [symbol] |
| Key5 | Key6 | Key7 | Key8 |

In “Table 2” in the image below, “Table 1” is presented, except with a header row. In this table, every header is unique.

TABLE 2

| A | B | C | D |
|---|---|---|---|
| row2_column1_ | [symbol] | row2_column3_value1 | row2_column4_value1 |
| value | | row2_column3_value2 | row2_column4_value2 |
| | | | [symbol] |
| Keyl | Key2 | Key3 | Key4 |
| row4_column1_ | [symbol] | row4_column3_value1 | row4_column4_value1 |
| value | | row4_column3_value2 | row4_column4_value2 |
| | | | [symbol] |
| Key5 | Key6 | Key7 | Key8 |

In “Table 3” in the image below, “Table 1” is presented, except with a header row. In this table, there are two core headers: A and B. Each header is repeated twice in the header row.

TABLE 3

| A | B | A | B |
|---|---|---|---|
| row2_column1_ | [symbol] | row2_column3_value1 | row2_column4_value1 |
| value | | row2_column3_value2 | row2_column4_value2 |
| | | | [symbol] |
| Key1 | Key2 | Key3 | Key4 |
| row4_column1_ | [symbol] | row4_column3_value1 | row4_column4_value1 |
| value | | row4_column3_value2 | row4_column4_value2 |
| | | | [symbol] |
| Key5 | Key6 | Key7 | Key8 |

In “Table 4” in the image below, “Table 1” is presented, except with a header row. In this table, there are two core headers: A and B. Only the “A” header is repeated in the header row in this case.

TABLE 4

| A | B | A | A |
|---|---|---|---|
| row2_column1_ | [symbol] | row2_column3_value1 | row2_column4_value1 |
| value | | row2_column3_value2 | row2_column4_value2 |
| | | | [symbol] |
| Key1 | Key2 | Key3 | Key4 |
| row4_column1_ | [symbol] | row4_column3_value1 | row4_column4_value1 |
| value | | row4_column3_value2 | row4_column4_value2 |
| | | | [symbol] |
| Key5 | Key6 | Key7 | Key8 |

### 1.3.4.7 Table Subtype: “First_Header_Cell_Absent”

A Table of the “first_header_cell_absent” subtype is a Table that has one or more header rows, and in each of these header rows, the first cell in a header row is absent. In the parsed JSON for tables of this subtype, the first element in each value row is the key for a JSON object that contains the headers associated with the rest of the values in the table. In the next four Table examples, a Table object of the “first_header_cell_absent” subtype is presented.

In “Table 1” in the image below, every header is unique.

TABLE 1

| | A | B | C | D | E |
|---|---|---|---|---|---|
| value1-1 | value1-2 | value1-3 | value1-4 | value1-5-1 | value1-6-1 |
| | | | | value1-5-2 | value1-6-2 |
| | | | | | [symbol] |
| value2-1 | value2-2 | value2-3 | value2-4 | value2-5-1 | value2-6-1 |
| | | | | value2-5-2 | value2-6-2 |
| | | | | | [symbol] |

In “Table 2” in the image below, there are repeated headers.

TABLE 2

| | A | B | C | A | B |
|---|---|---|---|---|---|
| value1-1 | value1-2 | value1-3 | value1-4 | value 1-5-1 | value1-6-1 |
| | | | | value 1-5-2 | value1-6-2 |
| | | | | | [symbol] |
| value2-1 | value2-2 | value2-3 | value2-4 | value2-5-1 | value2-6-1 |
| | | | | value2-5-2 | value2-6-2 |
| | | | | | [symbol] |

In “Table 3” in the image below, there are two header rows with no repeated headers.

TABLE 3

| | header1 | | | header2 | |
|---|---|---|---|---|---|
| | header1-1 | header1-2 | header1-3 | header2-1 | header2-2 |
| value1-1 | value1-2 | value1-3 | value1-4 | value1-5-1 | value1-6-1 |
| | | | | value1-5-2 | value1-6-2 |
| | | | | | [symbol] |
| value2-1 | value2-2 | value2-3 | value2-4 | value2-5-1 | value2-6-1 |
| | | | | value2-5-2 | value2-6-2 |
| | | | | | [symbol] |

In “Table 4” in the image below, there are two header rows in which the “A” header is repeated.

TABLE 4

| | header1 | | | header2 | |
|---|---|---|---|---|---|
| | A | B | A | A | A |
| value1-1 | value1-2 | value1-3 | value1-4 | value1-5-1 | value1-6-1 |
| | | | | value1-5-2 | value1-6-2 |
| | | | | | [symbol] |
| value2-1 | value2-2 | value2-3 | value2-4 | value2-5-1 | value2-6-1 |
| | | | | value2-5-2 | value2-6-2 |
| | | | | | [symbol] |

In “Table 5” in the image below, there are two header rows, but the first header row only has one header (or more in some embodiments), and this header is a super header for only two of the headers on the second header row (or more in some embodiments). This table is inspired by “TBL 4-1-1” in (U.S. Department of Transportation, 2023a).

TABLE 5

| | | | | header | |
|---|---|---|---|---|---|
| | A | B | C | D | E |
| value1-1 | value1-2 | value1-3 | value1-4 | value1-5 | value1-6 |
| value2-1 | value2-2 | value2-3 | value2-4 | value2-5 | value2-6 |

### 1.3.4.8 Table Subtype: “Changing_Headers”

A Table with the “changing_headers” characteristic is a Table in which the header or headers for values under the header row or header rows change at least once.

In “Table 1” in the image below, there are two headers in one header row in the table, and these headers change after one value row.

TABLE 1

| A | B | | |
|---|---|---|---|
| value_1-1 | value_1-2 | | |
| C | D | | |
| value_2-1 | value_2-2 | | |
| | A | B | C |
| value_2-1 | value1_1 | | |

This is an indented paragraph in cell 2.
Left Indentation Level: 2
This is a paragraph in cell 2.

In “Table 2” in the image below, there are two headers in each header row, but the first header cell in each header row is empty. This table example is technically a combination of two table subtypes: “changing_headers” and “first_header_cell_absent”. This example is based on “TBL 5-1-2” in (U.S. Department of Transportation, 2023b).

TABLE 2

| | [symbol] | | [symbol] | |
|---|---|---|---|---|
| value_1-1 | value_1-2 | | value_1-3 | |
| | [symbol] | | [symbol] | |
| value_2-1 | value_2-2 | | value_2-3 | |
| | | Value Table | | |
| | | A | B | C |
| value_3-1 | value_3-1 | value1_1 | value1_2 | value1_3 |
| | | value2_1 | value2_2 | value2_3 |

This is an indented paragraph in cell 3.
Left Indentation Level: 2
This is a paragraph in cell 3.

### 1.3.5 ParagraphRow

A ParagraphRow object is an object in which a table with one row and two or three columns is placed in the document. This table should span the width of the document, and should have all its borders removed. Each cell in this invisible table contains a Paragraph object. When there are two cells in a ParagraphRow object, the first cell's Paragraph object is aligned to the left of the cell. The second cell's Paragraph object is aligned to the right of the cell. In “ParagraphRow 1” in the image below, the ParagraphRow object has two cells.

Paragraph Row 1

| | |
|---|---|
| This is a paragraph in cell 1. | This is paragraph 1 in cell 2. |
| | This is paragraph 2 in cell 2. |

When there are three cells in a ParagraphRow object, the first cell's Paragraph object is aligned to the left of the cell. The second cell's Paragraph object is aligned in the center of the cell. The third cell's Paragraph object is aligned to the right of the cell. In “ParagraphRow 2” in the image below, the ParagraphRow object has three cells.

ParagraphRow 2

| | |
|---|---|
| This is a paragraph in cell 1 | This is paragraph 1 m cell 3. |
| | This is paragraph 2 in cell 3. |

This is a paragraph in cell 2.

### 1.3.6 Header and Footer

The Header and Footer objects can, in some examples, be a MICROSOFT WORD header or footer placed at the top or bottom of a page.

One or more aspects may include an encoder-decoder network system that can be trained to convert a document into a JSON string. According to some aspects, in a documented experiment with this system, the system achieved an accuracy of 99.99% on its simulated testing documents. Embodiments described herein provide for an artificial intelligence system that can convert a simulated document into a JSON string. A document parsing AI system is different than a system that simply reads the text in a document. Instead, a document parsing AI system places the text that is present in a document into a structured JSON file.

The training, validation, and testing data for the AI system may be simulated in some cases, meaning it might not use data generated from non-simulated documents (e.g., actual documents). In one non-limiting example, the data simulates an extremely small document with only text written inside it. In one non-limiting example, each simulated document will contain text with only the digits 0-9. These digits can have two characteristics in one example: bold or non-bold. In one non-limiting example, in simulated documents, one string, in bold, is the key, and one or two strings, not in bold, are the values for the key. In one non-limiting example, each string in the data can only have 1-10 characters, and this number is selected randomly. In one non-limiting example, each digit in a string is also selected randomly.

These simulated documents simulate KeyValuePair objects described herein. These simulated documents simulate four value types of KeyValuePair objects: right_offset, left_under, right_offset_list, and left_under_list. The right_offset and left_under value types have only one string for the value (or more in some embodiments). The right_offset_list, and left_under_list value types have only two strings for the value (or more in some embodiments).

The value for a right_offset KeyValuePair “is one string to the right of the key” (Norsworthy, 2022, p. 2). An example is shown below.
7353798 28105

A parsed JSON representation of the above document is shown below. {“7353798”: “28105”}

The value for a left_under KeyValuePair “is one string under the key and aligned to the left of the key” (Norsworthy, 2022, p. 3). An example is shown below.
739598
99123

A parsed JSON representation of the above document is shown below.

{“739598”:“99123”}

The value for a right_offset_list KeyValuePair “is a list of strings to the right of the key”. “Each string in this list of strings is placed under the first string in the list and is aligned to the left of the first string in the list” (Norsworthy, 2022, p. 4). An example is shown below.
944 9033
418961685

A parsed JSON representation of the above document is shown below.

{“944”: [“9033”, “418961685”]}

The value for a left_under_list KeyValuePair “is a list of strings aligned left under the key” (Norsworthy, 2022, p. 5). An example is shown below.
7153
304
86541

A parsed JSON representation of the above document is shown below.
{“7153”:[“304”, “86541”]}

A digit in a simulated document is stored in memory using one-hot encoding (Brownlee, 2020) with a cardinality of 47. A series of 4 one-hot encoded vectors describe a single digit, encoding what the digit is (0-9), the digit's x coordinate, the digit's y coordinate, and whether the digit is bold. Consider a document with 30 digits, corresponding to a simulated document with the greatest number of digits possible for this example. This document's input encoding will be a list of 30*4=120 one-hot encoded vectors of length 47. The output of the network can be written as a string of characters, which, if the network produces a correct output, will be a JSON string.

The network that is trained is an encoder-decoder network (Cho, 2014) with an attention (Bahdanau, 2014) layer. The network uses Long Short-Term Memory (Hochreiter & Schmidhuber, 1997) layers and each LSTM layer has 50 units. The encoder is composed of two bidirectional (Schuster & Paliwal, 1997) LSTMs. The decoder is composed of four LSTMs. The attention layer is an additive attention layer, also known as Bahdanau attention (Bahdanau, 2014). This model contains some of the recommendations from an article entitled “How to Configure an encoder-decoder Model for Neural Machine Translation” (Brownlee, 2019). The model is implemented using the Keras library (Keras, n.d.a), a library which was also used to produce the complete network summary shown below.

Model: “KeyValuePairParser”

| Layer (type) | Output Shape |
|---|---|
| network in (InputLayer) | [(None, None, 47)] |
| dec_in (InputLayer) | [(None, None, 200)] |
| bdr enc 1 (Bidirectional) | [(None, None, 100), |
| | (None, 50), |
| | (None, 50), |
| | (None, 50), |
| | (None, 50)] |
| dec lstm 1 (LSTM) | [(None, None, 50), |
| | (None, 50), |
| | (None, 50)] |
| dec lstm 2 (LSTM) | [(None, None, 50), |
| | (None, 50), |
| | (None, 50)] |
| bdr enc 2 (Bidirectional) | [(None, None, 100), |
| | (None, 50), |
| | (None, 50), |
| | (None, 50), |
| | (None, 50)] |
| dec lstm 3 (LSTM) | [(None, None, 50), |
| | (None, 50), |
| | (None, 50)] |
| Param # | Connected to |
| 0 | [ ] |
| 0 | [ ] |
| 39200 | [‘network in[0][0]’] |
| 50200 | [‘dec in[0][0]’, |
| | ‘bdr enc 1[0][1]’, |
| | ‘bdr enc 1[0][2]’] |
| 20200 | [‘dec lstm 1[0][0]’, |
| | ‘bdr_enc_1[0][3]’, |
| | ‘bdr_enc_1[0][4]’] |
| 60400 | [‘bdr enc 1[0][0]’] |
| 20200 | [‘dec 1stm 2[0][0]’, |
| | ‘bdr enc 2[0][1]’, |
| | ‘bdr enc 2[0][2]’] |
| dec_lstm_4 (LSTM) | [(None, None, 50), |
| | (None, 50), |
| | (None, 50)] |
| dec1-4out (Concatenate) | (None, None, 200) |
| enc1-2out (Concatenate) | (None, None, 200) |
| attn layer (AdditiveAttention) | (None, None, 200) |
| dec-out attn-out (Concatenate) | (None, None, 400) |
| dense (Dense) | (None, None, 19) |
| 20200 | [‘dec_lstm_3[0][0]’, |
| | ‘bdr enc 2[0][3]’, |
| | ‘bdr enc 2[0][4]’] |
| 0 | [‘dec lstm 1[0][0]’, |
| | ‘dec lstm 2[0][0]’, |
| | ‘dec lstm 3[0][0]’, |
| | ‘dec_lstm_4[0][0]’] |
| 0 | [‘bdr enc 1[0][0]’, |
| | ‘bdr enc 2[0][0]’] |
| 200 | [‘dec1-4out[0][0]’, |
| | ‘enc1-2out[0][0]’] |
| 0 | [‘dec1-4out[0][0]’, |
| | ‘attn layer[0][0]’] |
| 7619 | [‘dec-out attn-out[0][0]’] |

Total params: 218,219
Trainable params: 218,219
Non-trainable params: 0

Before training the network, the training and validation data are generated. In some cases, evaluation may include validation and testing of the AI system. The training data has 20,000 simulated documents created for each of the four KeyValuePair value types, equaling 20,000*4=80,000 simulated documents in total. The validation data has 4,000 simulated documents created for each of the four KeyValuePair value types, equaling 4,000*4=16,000 simulated documents in total. After training, an additional 4,000 simulated documents for each KeyValuePair value type are newly generated, equaling 4,000*4=16,000 simulated documents. This is to test the network. The code uses an exact accuracy metric for testing. With this metric, if the network has one character in its output string that is incorrect for a given input, then the network has 0% accuracy for that simulated document. Then, an additional 10 simulated documents for each KeyValuePair value type are newly generated, equaling 10*4=40 simulated documents. The network evaluates these as input and the code writes output from the network into a string so the developer can see which, if any, written outputs are incorrect and how they are incorrect.

### 3. EXPERIMENT

The network was trained for 50 epochs with a batch size of 16 and a learning rate of 0.0015. The network was trained using the Adam optimizer (Kingma & Ba, 2014) with categorical cross-entropy loss (Keras, n.d.e). Although the system was trained for 50 epochs, the code saves the network weights with the best validation loss. The network's highest accuracy on the training data during training was 99.94%. The network's highest validation score during training was 100.00%. After training, the accuracy of the saved network using the exact accuracy metric on the testing data was 99.99%. Because disclosed embodiments were able to parse simulated documents that each simulate a KeyValuePair object this shows that disclosed embodiments provide for an encoder-decoder network that may parse any document that contains a KeyValuePair object similar to the KeyValuePair objects on which it was trained.

An example of a setup of a current system may be provided below.

```
  1 usage [symbol]  Charles A. Norsworthy
  def define_transformer_model( ):
  # https://machinelearningmastery.com/building-transformer-models-with-attention-crash-
  course-build-a-neural-mac
  inter_d = 512
  heads = 8
  drop_rate = 0.05
  network_in = Input(shape=(None, input_cardinality), name=′network_in′)
  # https://keras.io/api/keras_nlp/modeling_layers/sine_position_encoding/
  positional_encoding = SinePositionEncoding(name=′pos_enc′)(network_in)
  encoder_in = Concatenate(axis=-1, name=′enc_in′)([network_in, positional_encoding])
  encoder_out1 = TransformerEncoder(inter_d, heads, name=′tr_enc0′,
dropout=drop_rate)(encoder_in)
  encoder_out2 = TransformerEncoder(inter_d, heads, name=′tr_enc1′,
dropout=drop_rate)(encoder_out1)
  encoder_out3 = TransformerEncoder(inter_d, heads, name=′tr_enc2′,
dropout=drop_rate)(encoder_out2)
  encoder_out4 = TransformerEncoder(inter_d, heads, name=′tr_enc3′,
dropout=drop_rate)(encoder_out3)
  decoder_out1 = TransformerDecoder(inter_d, heads, name=′tr_dec0′,
dropout=drop_rate)(encoder_out4, encoder_in)
  decoder_out2 = TransformerDecoder(inter_d, heads, name=′tr_dec1′,
dropout=drop_rate)(decoder_out1, encoder_in)
  decoder_out3 = TransformerDecoder(inter_d, heads, name=′tr_dec2′,
dropout=drop_rate)(decoder_out2, encoder_in)
  decoder_out4 = TransformerDecoder(inter_d, heads, name=′tr_dec3′,
dropout=drop_rate)(decoder_out3, encoder_in)
  outputs = Dense(output_cardinality, activation=′softmax′)(decoder_out4)
  return Model(*args: network_in, outputs, name=′Transformer′)
```

Model: “Transformer”

| Layer (type) | Output Shape | Param # | Connected to |
|---|---|---|---|
| network_in (InputLayer) | [(None, None, 47)] | 0 | [ ] |
| pos_enc (SinePositionEncoding) | (None, None, 47) | 0 | [‘network_in[0][0]’] |
| enc_in (Concatenate) | (None, None, 94) | 0 | [‘network_in[0][0]’, |
| | | | ‘pos_enc[0][0]’] |
| tr_enc0 (TransformerEncoder) | (None, None, 94) | 130684 | [‘enc_in[0][0]’] |
| tr_enc1 (TransformerEncoder) | (None, None, 94) | 130684 | [‘tr_enc0[0][0]’] |
| tr_enc2 (TransformerEncoder) | (None, None, 94) | 130684 | [‘tr_enc1[0][0]’] |
| tr_enc3 (TransformerEncoder) | (None, None, 94) | 130684 | [‘tr_enc2[0][0]’] |
| tr_dec0 (TransformerDecoder) | (None, None, 94) | 164318 | [‘tr_enc3[0][0]’] |
| | | | ‘enc_in[0][0]’] |
| tr_dec1 (TransformerDecoder) | (None, None, 94) | 164318 | [‘tr_dec0[0][0]’, |
| | | | ‘enc_in[0][0]’] |
| tr_dec2 (TransformerDecoder) | (None, None, 94) | 164318 | [‘tr_dec1[0][0]’, |
| | | | ‘enc_in[0][0]’] |
| tr_dec3 (TransformerDecoder) | (None, None, 94) | 164318 | [‘tr_dec2[0][0]’, |
| | | | ‘enc_in[0][0]’] |
| dense (Dense) | (None, None, 19) | 1805 | [‘tr_dec3[0][0]’] |

Total params: 1,181, 813
Trainable params: 1,181,813
Non-trainable params: 0

According to some aspects, the AI system may be a computer system (e.g., such as shown in FIG. 6 and described herein) and may include a transformer. In some embodiments, the AI system may include the following: 4 TransformerEncoder (Keras, n.d.b) layers, 4 TransformerDecoder (Keras, n.d.c) layers, Intermediate dimension (Keras, n.d.b), (Keras, n.d.c) for TransformerEncoder and TransformerDecoder=512, Number of heads=8, use SinePositionEncoding (Keras, n.d.d).

The learning rate changes as the Transformer trains.

$$lrate = {d}_{model}^{- 0.5} \cdot min ( {step\_num}^{- 0.5} , step\_num \cdot {warmup\_steps}^{- 1.5} ) \qquad Equation$$

(Vaswani et al., 2017, p. 7).

Using code implementation from tutorial at (Tam, 2023) with warmup steps=1000

The following is a description of a dataset used in accordance with one or more disclosed embodiments. Simulated data may be used. For simulated documents, disclosed aspects may generate the characters, their positions, and whether or not they are bold. Disclosed aspects may simulate a small square document containing digits 0-9

Disclosed aspects may include digits are bold or non-bold.

Bold strings may be the keys, non-bold strings may be the values

According to some aspects, each string has 1-10 digits, string length selected randomly.

According to some aspects, each digit in string selected randomly.

According to some aspects, the object may be randomly positioned in the simulated document.

An example list of dataset objects may include:

```

[symbol]
KeyValuePair [symbol]
  right_offset [symbol]
  left_under [symbol]
  right_under [symbol]
  right_offset_list [symbol]
  right_offset_left_under_list [symbol]
  left_under_list [symbol]
  right_under_list [symbol]
LinesOfKeyValuePair [symbol]
Paragraph
```

Simulated LinesOfKeyValuePair objects may have: Two KeyValuePair objects per line,

Two lines of KeyValuePair objects, and/or All internal KeyValuePair objects will be left_under.

“A Paragraph object is text that is placed in the document.” (Norsworthy, 2022, p. 6). For example, a paragraph object may be a series of random strings separated by spaces: This is a sentence This is a sentence This is a sentence This is a sentence This is a sentence
This is a sentence

Simulated Paragraph objects may have one line.

In some cases, the test run data, in one example, may include:
[symbol] Training data→20,000*9=180,000 simulated documents
[symbol] Validation data→4,000*9=36,000 simulated documents
[symbol] Test data→4,000*9=36,000 simulated documents
[symbol] Spot check data→10*9=90 simulated documents
[symbol] Testing uses an exact accuracy metric, one character incorrect means all of that output is incorrect

### Test Run Experiment

[symbol] Trained for 50 epochs
[symbol] Batch size=16
[symbol] Adam optimizer
[symbol] Categorical cross-entropy loss
[symbol] Code saves weights with best validation loss
[symbol] Highest training data accuracy=99.94%
[symbol] Highest validation accuracy=99.96%
[symbol] Test accuracy with exact accuracy metric=97.17%

A Transformer may be trained on and accurately parse simulated documents and may parse real documents with the same objects.

In some cases, the text may include uppercase characters, lowercase characters, digit characters, and various other characters in the data pool, paragraph objects with more than one line, avoiding the creation of duplicate objects, use real and simulated data, and/or the like.

Disclosed aspects provide for training an AI system, such as a transformer (Vaswani et al., 2017), to parse simulated documents into JSON (JSON, n.d.). These simulated documents may contain one or more objects, such as one or more simulated KeyValuePair objects, one or more simulated LinesOfKeyValuePair objects, one or more simulated Paragraph objects, and/or the like. The trained AI system may, for example, parse documents from the Federal Aviation Administration (U.S. Department of Transportation, n.d.) into JSON.

The AI system may be a computer system (e.g., such as shown in FIG. 6 and described herein) and may include a transformer. In some embodiments, the transformer may contain four TransformerEncoder (Keras, n.d.b) layers and four TransformerDecoder (Keras, n.d. c) layers. The intermediate dimension (Keras, n.d.b) for each TransformerEncoder and each TransformerDecoder layer may be 512. The system may have eight heads (Keras, n.d.b), and use SinePositionEncoding (Keras, n.d.d). A Keras (Keras, n.d.a) summary of the system can be seen below.

Model: “Transformer”

| Layer (type) | Output Shape | Param # | Connected to |
|---|---|---|---|
| network_in (InputLayer) | [(None, None, 47)] | 0 | [ ] |
| pos_enc (SinePositionEncoding) | (None, None, 47) | 0 | [‘network_in[0][0]’] |
| enc_in (Concatenate) | (None, None, 94) | 0 | [‘network_in[0][0]’, |
| | | | ‘pos_enc[0][0]’] |
| tr_enc0 (TransformerEncoder) | (None, None, 94) | 130684 | [‘enc_in[0][0]’] |
| tr_enc1 (TransformerEncoder) | (None, None, 94) | 130684 | [‘tr_enc0[0][0]’] |
| tr_enc2 (TransformerEncoder) | (None, None, 94) | 130684 | [‘tr_enc1[0][0]’] |
| tr_enc3 (TransformerEncoder) | (None, None, 94) | 130684 | [‘tr_enc2[0][0]’] |
| tr_dec0 (TransformerDecoder) | (None, None, 94) | 164318 | [‘tr_enc3[0][0]’] |
| | | | ‘enc_in[0][0]’] |
| tr_dec1 (TransformerDecoder) | (None, None, 94) | 164318 | [‘tr_dec0[0][0]’, |
| | | | ‘enc_in[0][0]’] |
| tr_dec2 (TransformerDecoder) | (None, None, 94) | 164318 | [‘tr_dec1[0][0]’, |
| | | | ‘enc_in[0][0]’] |
| tr_dec3 (TransformerDecoder) | (None, None, 94) | 164318 | [‘tr_dec2[0][0]’, |
| | | | ‘enc_in[0][0]’] |
| dense (Dense) | (None, None, 19) | 1805 | [‘tr_dec3[0][0]’] |

Total params: 1,181,813
Trainable params: 1,181,813
Non-trainable params: 0

The learning rate changes as the Transformer is being trained. The equation that governs how the learning rate changes comes from the paper entitled “Attention is All You Need” (Vaswani et al., 2017), and is seen below.

$$lrate = {d}_{model}^{- 0.5} \cdot min ( {step\_num}^{- 0.5} , step\_num \cdot {warmup\_steps}^{- 1.5} )$$

(Vaswani et al., 2017, p. 7).

The code implementation of this equation that is used is based on an online tutorial (Tam, 2023), and is edited the warmup steps (Vaswani et al., 2017, p. 7) to be 1,000.

### Dataset

The data that is used for training, evaluating, and testing the network is simulated, meaning the data might not come from real documents. Here, a real document is a PDF (Adobe, 2023) document that can be used to get information about the characters in that PDF. Some information about the characters in a PDF is what a character is, its x position, its y position, and whether or not a character is bold. However, in one non-limiting example, with simulated documents, the only generated data are the characters, the x and y positions, and whether or not the characters are bold. The code might not have to generate or use a PDF to create a simulated document. Thus, a simulated document can be understood as a list of characters with their characteristics.

The simulated documents used in the final test run simulate a small square document containing characters that are the digits 0-9. The characters in these simulated documents are bold or non-bold. The bold strings are the keys, and the non-bold strings are the values for keys, or are part of a Paragraph. Each string can have 1-10 characters. Each character in a string is selected randomly. After the system finishes generating a KeyValuePair, LinesOfKey ValuePair, or a Paragraph object, the object will be randomly positioned in the simulated document. The different value types of KeyValuePair objects that are used are right_offset, left_under, right_under, right_offset_list, right_offset_left_under_list, left_under_list, and right_under_list.

The value for a right_offset KeyValuePair “is one string to the right of the key” (Norsworthy, 2022, p. 2). An example is shown below.
Name Charles Norsworthy

(Norsworthy, 2022, p. 3)

A visualization of a simulated document with one right_offset KeyValuePair is shown below. In these visualizations of simulated documents in this example, the purple area might not have any characters present, and the yellow areas have one or more characters present.

Also, these visualizations of simulated documents in this example were generated with Matplotlib (Matplotlib, 2023).

The value for a left_under KeyValuePair “is one string under the key and aligned to the left of the key” (Norsworthy, 2022, p. 3). An example is shown below.
Name
Charles Norsworthy

(Norsworthy, 2022, p. 3)

A visualization of a simulated document with one left_under KeyValuePair is shown below.

The value for a right_under KeyValuePair “is one string under the key, and this value is aligned to the right of the key” (Norsworthy, 2022, p. 3). An example is shown below.
Name
Charles Norsworthy

(Norsworthy, 2022, p. 3)

A visualization of a simulated document with one right_under KeyValuePair is shown below.

The value for a right_offset_list KeyValuePair is a list of strings to the right of the key”, and “each string in this list of strings is placed under the first string in the list and is aligned to the left of the first string in the list (Norsworthy, 2022, p. 4).

An example is shown below
Name Charles
Norsworthy

[symbol]

(Norsworthy, 2022, p. 4)

A visualization of a simulated document with one right_offset_list KeyValuePair is shown below.

The value for a right_offset_left_under_list KeyValuePair “is a list of strings”, and “the first string in this list is placed to the right of the key, and the rest of the strings in this list are placed under the key and are aligned to the left of the key” (Norsworthy, 2022, p. 4).

An example is shown below.
Name Charles
Norsworthy

[symbol]

(Norsworthy, 2022, p. 4)

A visualization of a simulated document with one right_offset_left_under_list Key ValuePair is shown below.

The value for a left_under_list KeyValuePair “is a list of strings aligned left under the key” (Norsworthy, 2022, p. 5). An example is shown below.
Name
Charles
Norsworthy

[symbol]

(Norsworthy, 2022, p. 5)

A visualization of a simulated document with one left_under_list KeyValuePair is shown below.

The value for a right_under_list KeyValuePair “is a list of strings under the key, and all strings in this list are aligned to the right of the key” (Norsworthy, 2022, p. 5). An example is shown below.
Name
Charles
Norsworthy

[symbol]

(Norsworthy, 2022, p. 5)

A visualization of a simulated document with one right_under_list Key ValuePair is shown below.

The next type of object is the LinesOfKey ValuePair object. “The LinesOfKeyValuePair object consists of one or more lines of one or more KeyValuePair objects” (Norsworthy, 2022, p. 5). An example is shown below.

| | | |
|---|---|---|
| Namel Charles | Name2 | Name3 |
| Norsworthy | Charles Norsworthy | Charles Norsworthy |
| Namel Charles | Name2 | Name3 |
| Norsworthy | Charles | Charles |
| | Norsworthy | Norsworthy |

According to some aspects, simulated LinesOfKeyValuePair objects have two KeyValuePair objects per line, two lines of KeyValuePair objects, and all internal KeyValuePair objects are of the left_under value type.

A visualization of a simulated document with one LinesOfKey ValuePair object is shown below.

Another object is the Paragraph object. “A Paragraph object is text that is placed in the document” (Norsworthy, 2022, p. 6).

According to some aspects, a Paragraph can also be understood as a series of random strings separated by spaces. An example is shown below.

This is a sentence This is a sentence This is a sentence This is a sentence This is a sentence This is a sentence

According to some aspects, simulated Paragraph objects may have one line of text, or more in some embodiments.

A visualization of a simulated document with one Paragraph object is shown below.

In the final test run, four different data pools were generated: training data, validation data, test data, and spot check data. There are nine different types of objects that are generated. In each data pool, a certain number of objects are generated for each type of object. The training data has 20,000 simulated documents created for each object type, equaling 20,000*9=180,000 simulated documents in total. The validation data has 4,000 simulated documents created for each object type, equaling 4,000*9=36,000 simulated documents in total. The test data has 4,000 simulated documents created for each object type, equaling 4,000*9=36,000 simulated documents in total. Finally, the spot check data has ten simulated documents created for each object type, equaling 10*9=90 simulated documents in total.

### Experiment

For the final test run, the network was trained for 50 epochs with a batch size of 16. The network was trained using the Adam optimizer (Kingma & Ba, 2014) with categorical cross-entropy loss (Keras, n.d.e). Although the system was trained for 50 epochs, the code saves the network weights with the best validation loss. The network's highest accuracy on the training data during training was 99.94%. The network's highest validation score during training was 99.96%. The code uses an exact accuracy metric for testing. With this metric, if the network has one character in its output string that is incorrect for a given input, then the network has 0% accuracy for that simulated document. After training, the accuracy of the saved network using the exact accuracy metric on the testing data was 97.17%.

### Additional Considerations

In cases where the data is randomly generated, there may be a chance of generating duplicate documents.

For example, in simulated data, the character positions of a simulated object may be different than the character positions for real data. The simulated data can be saved to a folder before training, instead of being freshly generated before training. The complete data pool may include both real and simulated data instead of only simulated data or of only real data in some embodiments. The dataset may include additional KeyValuePair value types. There may be additional variation with the LinesOfKeyValuePair objects. The Paragraph objects may include more than one line. The generated objects may include uppercase and lowercase characters (a-z and A-Z), special characters, blank characters, and the like, such as in addition to digits.

According to some aspects, one or more disclosed embodiments may have one or more specific applications. Large government agencies (and other entities) regularly receive many documents from various sources, process them, and aggregate the information from them, all via human analysts. For example, there are many documents in use by the Navy. Having a way to store and/or database the information in these documents in an easily usable and/or machine readable format, as provided by disclosed embodiments, provides an incredible utility. Documents obtained by the Navy (or other entity) might not be in a familiar format, and parsing these documents and putting the information in a familiar format provides easy access to the information. For example, disclosed aspects may provide information that may be used for search & rescue, for safety of navigation, for military situational awareness, for implementing and/or developing a mission route plan associated with operating a vehicle, aircraft, vessel, and/or the like. According to some aspects, one or more disclosed aspects may be used to facilitate a water-based operation. In some cases, one or more disclosed aspects may be used to facilitate a strategic operation, which can include a defensive tactical operation or naval operation.

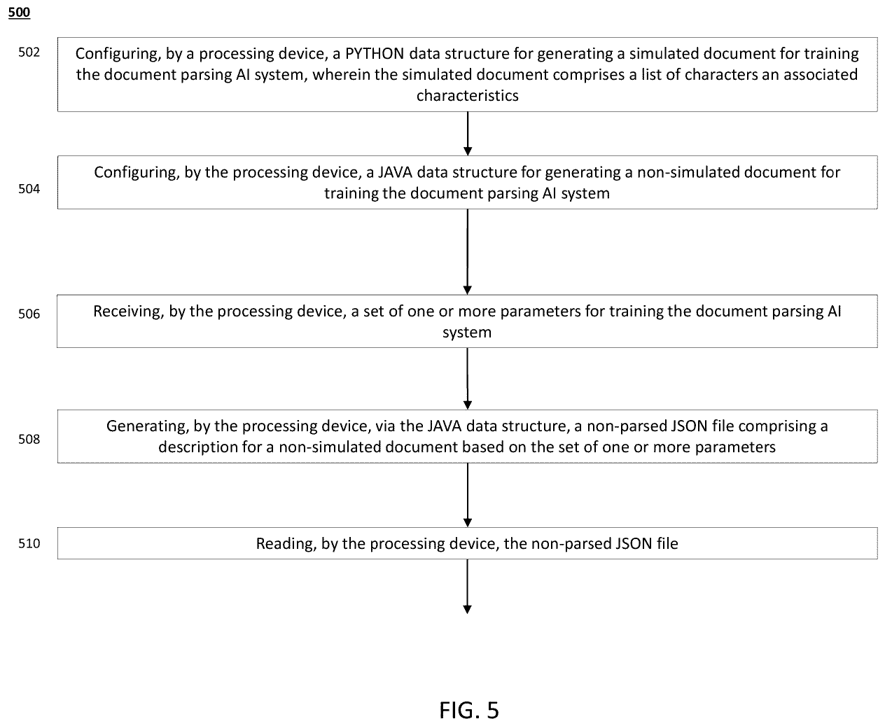

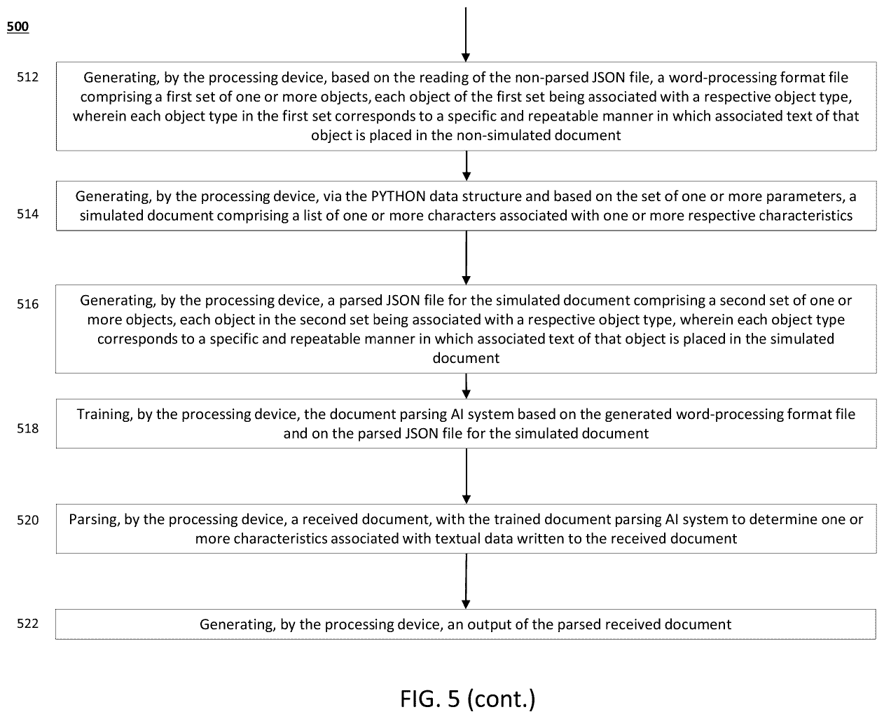

FIG. 5 illustrates an example method 500, in accordance with one or more disclosed aspects. For example, method 500 may be a method for training a document parsing artificial intelligence (AI) system. Step 502 may include configuring, by a processing device, a PYTHON data structure for generating a simulated document for training the document parsing AI system, wherein the simulated document comprises a list of characters and associated characteristics. Step 504 may include configuring, by the processing device, a JAVA data structure for generating a non-simulated document for training the document parsing AI system. Step 506 may include receiving, by the processing device, a set of one or more parameters for training the document parsing AI system. Step 508 may include generating, by the processing device, via the JAVA data structure, a non-parsed JSON file comprising a description for a non-simulated document based on the set of one or more parameters. Step 510 may include reading, by the processing device, the non-parsed JSON file. Step 512 may include generating, by the processing device, based on the reading of the non-parsed JSON file, a word-processing format file comprising a first set of one or more objects, each object of the first set being associated with a respective object type, wherein each object type in the first set corresponds to a specific and repeatable manner in which associated text of that object is placed in the non-simulated document. Step 514 may include generating, by the processing device, via the PYTHON data structure and based on the set of one or more parameters, a simulated document comprising a list of one or more characters associated with one or more respective characteristics. Step 516 may include generating, by the processing device, a parsed JSON file for the simulated document comprising a second set of one or more objects, each object in the second set being associated with a respective object type, wherein each object type corresponds to a specific and repeatable manner in which associated text of that object is placed in the simulated document. Step 518 may include training, by the processing device, the document parsing AI system based on the generated word-processing format file and on the parsed JSON file for the simulated document. Step 520 may include parsing, by the processing device, a received document, with the trained document parsing AI system to determine one or more characteristics associated with textual data written to the received document. Step 522 may include generating, by the processing device, an output of the parsed received document. One or more steps may be repeated, added, modified, and/or excluded. One or more steps can be provided as feedback to any other step.

One or more aspects described herein may be implemented on virtually any type of computer regardless of the platform being used. For example, as shown in FIG. 6, a computer system 600 includes a processor 602, associated memory 604, a storage device 606, and numerous other elements and functionalities typical of today's computers (not shown). The computer 600 may also include input means 608, such as a keyboard and a mouse, and output means 612, such as a monitor or LED (e.g., may be used for generating and/or outputting an output of a parsed document, such as provided by and/or generated by an AI system). The computer system 600 may be connected to a local may be a network (LAN) or a wide may be a network (e.g., the Internet) 614 via a network interface connection (not shown). Those skilled in the art will appreciate that these input and output means may take other forms.

Further, those skilled in the art will appreciate that one or more elements of the aforementioned computer system 600 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments training a document parsing artificial intelligence (AI) system have been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### REFERENCES

Rausch, J., Martinez, O., Bissig, F., Zhang, C., & Feuerriegel, S. (2021 May). Docparser: Hierarchical document structure parsing from renderings. In Proceedings of the AAAI Conference on Artificial Intelligence (Vol. 35, No. 5, pp. 4328-4338).
The Apache Software Foundation. (2023 Dec. 31). Apache POI. Apache POI. https://poi.apache.org/
Johri, A. (2021 Dec. 11). docx2pdf 0.1.8. The Python Package Index. https://pypi.org/project/docx2pdf/
Unicode Consortium. (n.d.a). Miscellaneous Symbols. Unicode. https://unicode.org/charts/nameslist/n_2600.html
Unicode Consortium. (n.d.b). Geometric Shapes. Unicode. http://www.unicode.org/charts/nameslist/n_25A0.html
Microsoft. (2024). Microsoft Word. https://www.microsoft.com/en-us/microsoft-365/word
U.S. Department of Transportation. (2022 Aug. 9). FEDERAL AVIATION ADMINISTRATION FLIGHT STANDARDS SERVICE ILS STANDARD INSTRUMENT APPROACH PROCEDURE TITLE 14 CFR PART 97.29. Federal Aviation Administration. https://www.faa.gov/aero_docs/acifp/NDBR/EF8174323547427B90AFF1CBFA21COAD-HDC-NDBR/LA_HAMMOND_IL18_HDC.pdf
U.S. Department of Transportation. (2023 Oct. 5a). Section 1. Services Available to Pilots. Federal Aviation Administration. https://www.faa.gov/air_traffic/publications/atpubs/aim_html/chap4_section_1.html
U.S. Department of Transportation. (2023 Oct. 5b). Section 1. Preflight. Federal Aviation Administration. https://www.faa.gov/air_traffic/publications/atpubs/aim_html/chap5_section_1.html
U.S. Department of Transportation. (2024 Jan. 9). Forms. Federal Aviation Administration. https://www.faa.gov/forms/
Belval, E. (2024 Jan. 7). pdf2image 1.17.0. The Python Package Index. https://pypi.org/project/pdf2image/
JSON. (n.d.). Introducing JSON. https://www.json.org/json-en.html
U.S. Department Of Transportation. (n.d.). Transmittal Letters. Federal Aviation Administration. https://www.faa.gov/air_traffic/flight_info/aeronav/aero_data/Transmittal_Letters/
Norsworthy, C. (2022 Dec. 13). Synthetic Data Generation Project for a Document Parsing AI. Defense Technical Information Center. https://apps.dtic.mil/sti/pdfs/AD1187927.pdf
Brownlee, J. (2020 Jun. 12). Ordinal and One-Hot Encodings for Categorical Data. Machine Learning Mastery. https://machinelearningmastery.com/one-hot-encoding-for-categorical-data/
Cho, K., Van Merrienboer, B., Gulcehre, C., Bahdanau, D., Bougares, F., Schwenk, H., & Bengio, Y. (2014). Learning phrase representations using RNN encoder-decoder for statistical machine translation. arXiv preprint arXiv: 1406.1078.
Bahdanau, D., Cho, K., & Bengio, Y. (2014). Neural machine translation by jointly learning to align and translate. arXiv preprint arXiv: 1409.0473.
Hochreiter, S., & Schmidhuber, J. (1997). Long short-term memory. Neural computation, 9 (8), 1735-1780.
Schuster, M., & Paliwal, K. K. (1997). Bidirectional recurrent neural networks. IEEE transactions on Signal Processing, 45 (11), 2673-2681.
Brownlee, J. (2019 Aug. 7). How to Configure an Encoder-Decoder Model for Neural Machine Translation. Machine Learning Mastery. https://machinelearningmastery.com/configure-encoder-decoder-model-neural-machine-translation/
Tam, A. (2023 Jan. 9). Building Transformer Models with Attention Crash Course. Build a Neural Machine Translator in 12 Days. Machine Learning Mastery. https://machinelearningmastery.com/building-transformer-models-with-attention-crash-course-build-a-neural-machine-translator-in-12-days/Keras.
Keras. (n.d.a). https://keras.io/
Keras. (n.d.b). TransformerEncoder layer. https://keras.io/api/keras_nlp/modeling_layers/transformer_encoder/
Keras. (n.d.c). TransformerDecoder layer. https://keras.io/api/keras_nlp/modeling_layers/transformer_decoder/
Keras. (n.d.d). SinePositionEncoding layer. https://keras.io/api/keras_nlp/modeling_layers/sine_position_encoding/
Keras. (n.d.e). Probabilistic losses. https://keras.io/api/losses/probabilistic_losses/#categoricalcrossentropy-class
Kingma, D. P., & Ba, J. (2014). Adam: A method for stochastic optimization. arXiv preprint arXiv: 1412.6980.
Matplotlib. (2023). Matplotlib: Visualization with Python. https://matplotlib.org/
Adobe. (2024). Everything you need to know about the PDF. https://www.adobe.com/acrobat/about-adobe-pdf.html
The Apache Software Foundation. (2024). Apache PDFBox®—A Java PDF Library. PDFBox®. https://pdfbox.apache.org/
Vaswani, A., Shazeer, N., Parmar, N., Uszkoreit, J., Jones, L., Gomez, A. N., . . . & Polosukhin, I. (2017). Attention is all you need. Advances in neural information processing systems, 30.

What is claimed is:

1. A method of training a document parsing artificial intelligence (AI) system, the method comprising:
configuring, by a processing device, a PYTHON data structure for generating a simulated document for training the document parsing AI system, wherein the simulated document comprises a list of characters and associated characteristics;
configuring, by the processing device, a JAVA data structure for generating a non-simulated document for training the document parsing AI system;
receiving, by the processing device, a set of one or more parameters for training the document parsing AI system;
generating, by the processing device, via the JAVA data structure, a non-parsed JSON file comprising a description for a non-simulated document based on the set of one or more parameters;
reading, by the processing device, the non-parsed JSON file;
generating, by the processing device, based on the reading of the non-parsed JSON file, a word-processing format file comprising a first set of one or more objects, each object of the first set being associated with a respective object type, wherein each object type in the first set corresponds to a specific and repeatable manner in which associated text of that object is placed in the non-simulated document;
generating, by the processing device, via the PYTHON data structure and based on the set of one or more parameters, a simulated document comprising a list of one or more characters associated with one or more respective characteristics;
generating, by the processing device, a parsed JSON file for the simulated document comprising a second set of one or more objects, each object in the second set being associated with a respective object type, wherein each object type corresponds to a specific and repeatable manner in which associated text of that object is placed in the simulated document;
training, by the processing device, the document parsing AI system based on the generated word-processing format file and on the parsed JSON file for the simulated document;
parsing, by the processing device, a received document, with the trained document parsing AI system to determine one or more characteristics associated with textual data written to the received document; and
generating, by the processing device, an output of the parsed received document.

2. The method of claim 1, wherein the training comprises training the document parsing AI system with training data derived from the generated word-processing format file associated with non-simulated document and confirming an accuracy of the training based on the parsed JSON file for the simulated document.

3. The method of claim 2, wherein confirming the accuracy comprises determining whether the AI system can identify data associated with the generated word-processing format file and a measure of correlation with parsed information in the parsed JSON file for the simulated document.

4. The method of claim 1, wherein determining whether to process the set with a JAVA data structure or a PYTHON data structure comprising a random determination.

5. The method of claim 1, wherein the first set of one or more objects correspond to the second set of one or more objects.

6. The method of claim 1, wherein the first set of one or more objects are randomly generated having one or more random strings.

7. The method of claim 1, wherein the second set of one or more objects are randomly generated having one or more random strings.

8. The method of claim 1, wherein the first set of one or more objects comprises a KeyValuePair object.

9. The method of claim 8, wherein an object type associated with the KeyValuePair object comprises one of the following: “right_offset,” “left_under,” “right_offset_list,” or “left_under_list.”

10. The method of claim 1, wherein the second set of one or more objects comprises a KeyValuePair object.

11. The method of claim 10, wherein an object type associated with the KeyValuePair object comprises one of the following: “right_offset,” “left_under,” “right_offset_list,” or “left_under_list.”

12. The method of claim 1, wherein an object type associated with the first set of one or more objects comprises a table format characteristic.

13. The method of claim 1, wherein an object type associated with the second set of one or more objects comprises a table format characteristic.

14. The method of claim 1, wherein the one or more parameters are hard-coded configuration parameters.

15. The method of claim 1, wherein the one or more parameters comprise locational data.

16. The method of claim 1, wherein the one or more parameters comprise font data.

17. The trained document parsing AI system of claim 1.

18. The method of claim 1, wherein the training comprises training the document parsing AI system with training data derived from a plurality of documents.

19. The method of claim 1, wherein the one or more parameters comprise alignment information.
